(19) United States
(12) Patent Application Publication
(10) Pub. No.: US 2014/0301579 A1
(43) Pub. Date: Oct. 9, 2014

(54) Vibrating acoustic device

(71) Applicants: Yun Tang, Shenzhen (CN); Rongguan Zhou, Shenzhen (CN)

(72) Inventors: Yun Tang, Shenzhen (CN); Rongguan Zhou, Shenzhen (CN)

(73) Assignee: AAC ACOUSTIC TECHNOLOGIES (SHENZHEN) CO., LTD., Shenzhen (CN)

(21) Appl. No.: 14/228,447

(22) Filed: Mar. 28, 2014

(30) Foreign Application Priority Data
Apr. 5, 2013 (CN) 201320169064.5

(51) Int. Cl. H04R 1/00

(52) U.S. Cl. CPC H04R 1/00
USPC 381/162

(57) ABSTRACT

Disclosed is a vibrating acoustic device. The vibrating acoustic device for generating sound in full frequency band includes a magnetic system, a first vibrating assembly mounted on an upper side of the magnetic system for generating sound in low-frequency region and a second vibrating assembly attached on a lower side of the magnetic system for generating sound in high-frequency and medium-frequency range. The first vibrating assembly includes a vibrating plate for resonating with a resonate medium for resonating and radiating sound in low-frequency region, and a first coil partially inserted in the magnetic gap and driving the vibrating plate; and the second vibrating assembly includes a diaphragm and a second coil driving the diaphragm.

### FIELD OF THE INVENTION

The present invention generally relates to an acoustic device, and more particularly, to a vibrating acoustic device for generating high-frequency, medium-frequency and low-frequency acoustic waves.

### DESCRIPTION OF RELATED ART

With the rapid development of technologies, the design of electronic devices, such as cellular phones, PDAs (personal digital assistants), and so on, is being driven by the marketplace towards providing more and more multimedia functions. At the same time, consumer's demand has been continuing to push a dramatic reduction in the size of the electronic devices.

To comply with the multimedia requirements and reduce the size of the electronic devices, most electronic devices today include an vibrating acoustic device for generating audible sounds through vibration. The vibrating acoustic device comprises a holder, a vibrating system and a magnetic system received in the holder, respectively. The vibrating system comprises a coil and a diaphragm driven by the coil. Such an acoustic device only provides sounds with a certain range of frequency, e.g. high frequency sound, or mediate frequency sound. If an electronic device need full frequency band sounds, three acoustic devices are needed to perform the high frequency sound, mediate frequency sound, and low frequency sound, respectively, which obviously increases the cost.

### BRIEF DESCRIPTION OF THE DRAWINGS

FIG. 1 is an illustrative cross-sectional view of a vibrating acoustic device in accordance with an exemplary embodiment of the present disclosure.

FIG. 2 is also an illustrative cross-sectional view of a vibrating acoustic device, which is similar to the device in FIG. 1.

### DETAILED DESCRIPTION OF THE EXEMPLARY EMBODIMENT

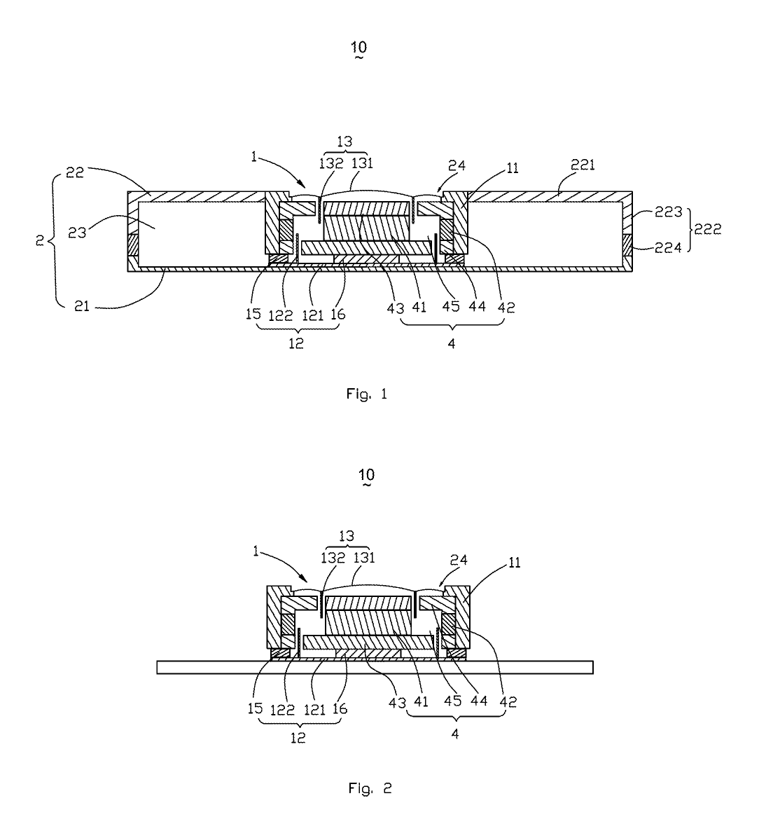

Referring to FIG. 1, a vibrating acoustic device 10 in accordance with an exemplary embodiment of the present disclosure comprises a frame 2 and a vibrating unit 1 received in the frame 2 for generating sound in all frequency bands including low-frequency.

The frame 2 comprises a lower panel 21, a cover 22 mounted on the lower panel 21, a receiving space 23 formed by the lower panel 21 and the cover 22, and an acoustic hole 24 formed in the upper cover 22 and opposite to the lower panel 21.

The vibrating unit 1 comprises a holder 11, a first vibrating system 12 mounted on a lower portion of the holder 11, a second vibrating system 13 attached on an upper portion of the holder 11, and a magnetic system 4 received in the holder 11. The holder 11 has a hollow space for receiving the magnetic system 4 and the first and second vibrating systems 12, 13.

The magnetic system 4 comprises a first magnetic conduction member 41, a second magnetic conduction member 42 surrounding the first magnetic conduction member 41, a pair of first pole plates 43 attached on two sides of the first magnetic conduction member 41, a pair of second pole plates 44 attached on two sides of the second magnetic conduction member 42, and a magnetic gap 45 formed by outer surfaces of the first magnetic conduction member 41 and the first pole plates 43 together with the inner surfaces of the second magnetic conduction member 42 and the second pole plates 44. The first and second pole plates 43, 44 are made of magnetic conduction materials for effectively conducting magnetic fluxes, respectively. In this embodiment, the first and second magnetic conduction members 41, 42 are permanent magnets. Optionally, in an alternative embodiment, at least one of the first and second magnetic conduction members 41, 42 is a permanent magnet. And the first and second pole plates 43, 44 may be omitted for reducing the whole volume of the system.

The first vibrating system 12 comprises a vibrating plate 121 attached on a lower side of the holder 11 for resonating with a resonate media (e.g., the lower panel) to resonate and radiating sound in low-frequency region, a first coil 122 connected with the vibrating plate 121 and a first elastic supporting member 16 mounted the vibrating plate 121 and surrounded by the first coil 122 for elastically supporting the first magnetic conduction member 41 and providing a pre-pressure to the vibrating plate 121. The first coil 122 has an end inserted and suspended in the magnetic gap 45 and another end directly or indirectly connected with the vibrating plate 121 for driving the vibrating plate 121. An upper side of the vibrating plate 121 is attached on the lower part of the holder 11 and the lower side of the vibrating plate 121 is coupled with the lower panel 21. The magnetic system 4 cooperates with the first coil 122 to drive the vibrating plate 121 to vibrate for causing the lower panel 21 coupled with the vibrating plate 121 to resonate and radiate sound in low-frequency region, such as sounds with frequency under 600 Hz.

Optionally and improvably, the first vibrating system 12 further comprises a second elastic supporting member 15 sandwiched between the lower side of the holder 1 and a the second pole plate 44 for elastically supporting the holder 1. A part of the second pole plates also attach on the second elastic supporting member 15. The second elastic supporting member 15 surrounds the first coil 122. The first and second elastic supporting members 16, 15 are made of soft silicone or foam.

The second vibrating system 13 comprises a diaphragm 131 attached on an upper side of the holder 11 and partially exposed from the acoustic hole 24, and a second coil 132 having an end inserted and suspended in the magnetic gap 45 and another end directly or indirectly connected with the diaphragm 131 for driving the diaphragm 131. When the second coil 132 is activated by an electric audio signal, an electromagnetic force occurs between the second coil 132 and the magnetic system 4. This forces the diaphragm 131 to vibrate, thereby generating high and medium frequency sounds which are emitted to an environment perceivable by a listener.

The cover 22 has an upper plate 221 surrounding the acoustic hole 24 and a sidewall 222 extending from the upper plate 221 and coupled to the lower panel 21. The sidewall 222 comprises a supporting wall 223 for supporting the upper plate 221 and an elastic wall 224 connecting with the supporting wall 223 and the lower plane 21 for absorbing the vibration generating from the lower plane 21 and the first vibrating system 12 and for preventing the vibration generated by the lower plane 21 and the first vibrating system 12 influencing the sound quality of the second vibrating system 13.

The first magnetic conduction member 41 is spaced from the second magnetic conduction member 42 for forming the magnetic gap 45 shared by the first and second coils 122, 132. In an alternative embodiment, the first magnetic conduction member is partially connected with a second magnetic conduction member for dividing the magnetic gap discussed above into two separated parts, such as a first magnetic gap for partially receiving the first coil and a second magnetic gap for partially receiving the second coil. Additional, the second magnetic conduction member is capable of supporting the first magnetic conduction member, thereby the first elastic supporting member can be omitted.

In an alternative embodiment, referring to FIG. 2, the frame can be omitted. The vibrating plate 12 is directly coupled with an external resonant media other than the lower panel, such as computers, mobile phone screens desktop, or other media to resonate and radiate the low-frequency acoustic output. In an optional embodiment, the holder can be omitted and the vibrating system is mounted on the magnetic system. For example, the second vibrating system is mounted on an upper side of the magnetic system and the first vibrating system is mounted on a lower side of the magnetic system.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A vibrating acoustic device comprising:
a holder having a hollow space;
a magnetic system received in the hollow space and comprising a magnetic gap;
a vibrating assembly mounted with the holder and at least partially inserted in the magnetic gap, the vibrating assembly comprising a first vibrating assembly mounted on an upper portion of the holder for generating low frequency sound and a second vibrating assembly attached on a lower portion of the holder for generating high and medium frequency sound;
wherein the first vibrating assembly comprises a vibrating plate for resonating with a resonate medium for resonating and radiating low frequency sound and a first coil partially inserted in the magnetic gap and driving the vibrating plate; and
the second vibrating assembly comprises a diaphragm and a second coil partially inserted in the magnetic gap for driving the diaphragm.

2. The vibrating acoustic device as described in claim 1 further comprising a first elastic supporting member sandwiched between the magnetic system and the vibrating plate of the first vibrating system, and surrounded by the first coil for elastically supporting the magnetic system.

3. The vibrating acoustic device as described in claim 2 further comprising a second elastic supporting member sandwiched between the magnetic system and the vibrating plate of the first vibrating system, and surrounding the first coil for elastically supporting the magnetic system.

4. The vibrating acoustic device as described in claim 3, wherein the first and second elastic supporting members are made of soft silicone or foam, respectively.

5. The vibrating acoustic device as described in claim 1 further comprising a second elastic supporting member sandwiched between a lower side of the holder and the vibrating plate of the first vibrating system, and surrounding the first coil for supporting the magnetic system.

6. The vibrating acoustic device as described in claim 1 further comprising a cover mounted on the resonate medium for receiving the holder, and the cover has an upper plate, an acoustic hole surrounded by the upper plate for exposing a part of the diaphragm, and a sidewall extending from the upper plate and coupled to the lower panel.

7. The vibrating acoustic device as described in claim 6, wherein the sidewall comprises a supporting wall for supporting the upper plate and an elastic wall connecting with the supporting wall and the resonate medium for absorbing the vibration generating from the resonate medium.

8. The vibrating acoustic device as described in claim 1, wherein the magnetic system has a first magnetic conduction member and a second magnetic conduction member surrounding the first magnetic conduction member for forming the magnetic gap, at least one of the first and second magnetic conduction members is a permanent magnet.

9. The vibrating acoustic device as described in claim 8, wherein the first and the second magnetic conduction members are spaced from each other.

10. The vibrating acoustic device as described in claim 8, wherein the first and the second magnetic conduction members are partially connected with each other.

11. A vibrating acoustic device, comprising:
a magnetic system comprising a magnetic gap;
a vibrating assembly mounted on the magnetic system and partially inserted in the magnetic gap, the vibrating assembly comprising a first vibrating assembly mounted on an upper portion of the magnetic system for generating sound with low frequency and a second vibrating assembly attached on a lower portion of the magnetic system for generating sound with high and medium frequency;
wherein the first vibrating assembly comprises a vibrating plate for resonating with a resonate medium for resonating and radiating sound with low frequency, and a first coil partially inserted in the magnetic gap and driving the vibrating plate; and
the second vibrating assembly comprises a diaphragm and a second coil partially inserted in the magnetic gap for driving the diaphragm.

12. The vibrating acoustic device as described in claim 11 further comprising a first elastic supporting member sandwiched between the magnetic system and the vibrating plate of the first vibrating system, and surrounded by the first coil for elastically supporting the magnetic system.

13. The vibrating acoustic device as described in claim 12 further comprising a second elastic supporting member sandwiched between the magnetic system and the vibrating plate of the first vibrating system, and surrounding the first coil for elastically supporting the magnetic system.

14. The vibrating acoustic device as described in claim 13, wherein the first and second elastic supporting members are made of soft silicone or foam, respectively.

15. The vibrating acoustic device as described in claim 11, wherein the magnetic system has a first magnetic conduction member and a second magnetic conduction member surrounding the first magnetic conduction member for forming the magnetic gap, at least one of the first and second magnetic conduction members is a permanent magnet.

16. The vibrating acoustic device as described in claim 15, wherein the first and the second magnetic conduction members are spaced from each other.

17. The vibrating acoustic device as described in claim 15, wherein the first and the second magnetic conduction members are partially connected with each other.
